(19) United States
(12) Patent Application Publication
(10) Pub. No.: US 2012/0013171 A1
(43) Pub. Date: Jan. 19, 2012

(54) Spoke Nipple with an Anti-shock Structure and its Manufacturing Method

(76) Inventor: Wen Hsuan Chen, Taipei (TW)

(21) Appl. No.: 12/838,454

(22) Filed: Jul. 17, 2010

(51) Int. Cl. B60B 1/04; B21K 1/34; B60B 1/14

(52) U.S. Cl. 301/58; 29/894.345

(57) ABSTRACT

An anti-shock spoke nipple comprises: a nipple body, having a big opening and a small opening connected with each other, with a groove formed on the side of the small opening; a big opening untapped area, located inside the big opening; a clamping area, located inside the small opening and on the lateral side of the groove; and a small opening tapped area, located inside the small opening and configured between the big opening and the clamping area; wherein, when the spoke goes into the clamping area, threads are formed inside the clamping area to clamp the spoke.

### BACKGROUND OF INVENTION

1. Field of the Invention

This invention relates to an improvement in bicycle or motorcycle wire wheel, especially related to bicycle or motorcycle spoke nipple with anti-shock structure and its manufacturing method.

2. Description of Related Art

Wire wheels are used on most bicycles and motorcycles. Besides a rim and a tire, a wire wheel typically comprises a wire spoke assembly which comprises a hub, spokes and spoke nipples. Whereas, the rim is connected to the hub by several spokes under tension. At the end of each spoke is a specialized nut, called a nipple, which is used to adjust the tension in the spoke. The nipple is usually located at the rim end of the spoke.

During the riding of a bicycle or motorcycle, when the wheels bear loads and operate in constant speed, it will to reach a new dynamic balance. During this state, tension and compression force are applied to each spoke and spoke nipple several times every second. Such forces are most extreme at the thread point of the spokes and spoke nipples which leads to quick wear of the spoke and spoke nipple threads and as a result, without an anti-shock and break feature in the spoke nipple, the spoke can be easily break from the spoke nipple.

In order to overcome this problem, many have come out with an anti-loose spoke methods to be employed in manufacturing bicycle or motorcycle wheel, but the current spoke nipple's anti-break methods still lack an effective approach in solving the problem. The current anti-loose method in the spoke nipple mainly focus on coasting the spoke nipple thread with Teflon past (slippery free rubber), but the results are unsatisfactory. The other proposals are to install plastic material in the spoke nipple, but it not only has the problem of cost is too high, it also has metal recycle problem.

Responding to this case, the inventor, to actively seek solutions, bet on his many years' cumulated professional knowledge and design experience in manufacturing spoke, and by constantly experiment and test for improved for the above insufficient place, design and develop the invention of “A Spoke Nipple with an Anti-shock Structure and its Manufacturing Method” for the wide of the industry, and further to enhance the industry's competitiveness and added value.

### CONTENT OF INVENTION

The primary objective of the present invention is to provide an easy processing method enabling recycling of metal material and meanwhile avoiding breakage of screw thread. Using the metal on both sides of the groove, the present invention enables the spoke thread screwed in to tap out identical thread inside the untapped spoke nipple area or shallow-tapped groove area and to be clasped by the resilience of metal, eliminating the gap between the spoke and the nipple for anti-shock purpose and avoiding breakage of the screw thread. Due to enhanced anti-breakage performance of the spoke thread, the number of spokes can be reduced, further realizing the goal of lightweight.

Therefore, the present invention provides a production method of anti-shock spoke nipples, which comprises the following steps:

provides a spoke nipple body, which mainly comprises a groove head, a neck and a quadrangular part; drill a opening from the quadrangular part through the neck till the groove head, to form a big opening and a small opening connected with each other, wherein the big opening is on the side of the quadrangular part; the groove head is grooved to form a groove, and the groove is located on one side of the small opening, and inside the small opening on the side of the groove, a clamping area is formed; and the inside of the small opening is tapped, and between the big opening and the clamping area, a small opening tapped area is formed through tapping, wherein, the nipple body catches a spoke, and when the spoke goes into the clamping area, threads are formed in the clamping area to clamp the spoke.

The present invention also provides an anti-shock nipple to catch a spoke. The anti-shock spoke nipple comprises: a nipple body, having a big opening and a small opening connected with each other, with a groove formed on the side of the small opening; a big opening untapped area, located inside the big opening; a clamping area, located inside the small opening and on the lateral side of the groove; and a small opening tapped area, located inside the small opening and configured between the big opening and the clamping area; wherein, when the spoke goes into the clamping area, threads are formed inside the clamping area to clamp the spoke.

On this basis, the clamping area is an untapped groove area, or a shallow-tapped groove area formed through tapping.

The features and the advantages of the present invention will be more readily understood upon a thoughtful deliberation of the following detailed description of a preferred embodiment of the present invention with reference to the accompanying drawings.

### SUMMARY OF THE INVENTION

The above-mentioned and other purposes and advantages of the present invention can be easily understood through the following detailed descriptions of the selected embodiment and attached figures. The present invention may have variation in some parts or arrangements of parts. The selected embodiment is detailed in this specification and its structures are revealed through the attached figures, but the invention is not limited by what are described in the specification.

### BRIEF DESCRIPTION OF DRAWINGS

FIGS. 1 to 4 are the spoke nipple with an anti-shock structure first implementation of nested spoke diagrammatic cross-sections.

FIG. 5 is the spoke nipple with an anti-shock structure first implementation diagrammatic cross-section (1).

FIG. 6A is the spoke nipple with an anti-shock structure first implementation schematic diagram (2).

FIG. 6B is the spoke nipple with an anti-shock structure first implementation schematic diagram (3).

FIG. 7 is the spoke nipple with an anti-shock structure second implementation of nested spoke diagrammatic cross-section.

FIG. 8 is the spoke nipple with an anti-shock structure third implementation of nested spoke diagrammatic cross-section.

### DETAIL DESCRIPTION OF THE INVENTION

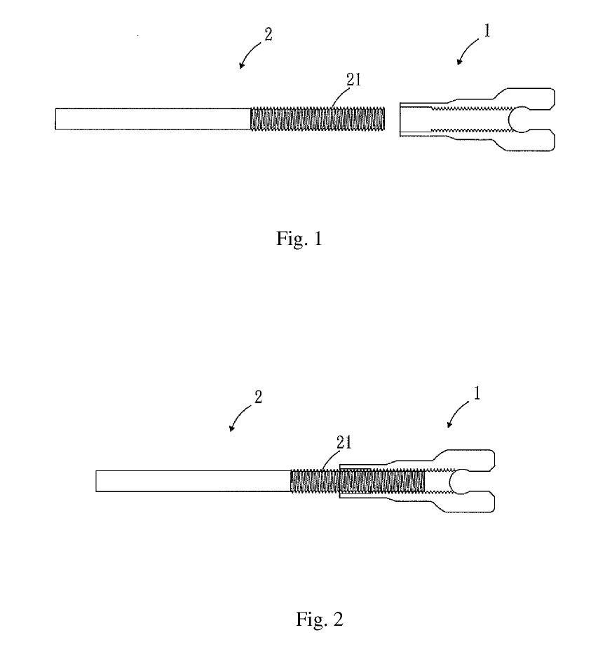

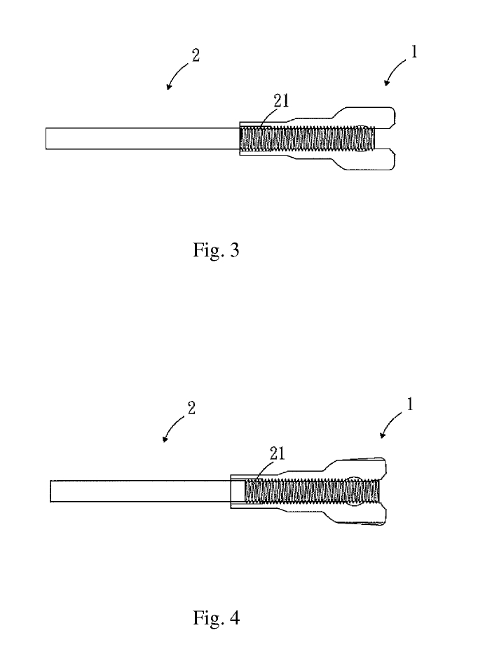

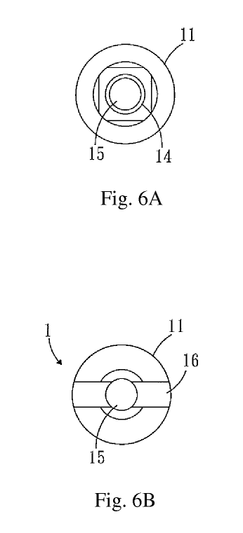

Referring to FIGS.1, 2, 3, 4, 5, 6A and 6B for the preferred embodiment of the present invention, which disclose the first embodiment of the present invention for description purpose only, and it shall be noted that the patent application is not restricted by such a structure.

The nipple body 1 of the anti-shock spoke nipple of the present invention mainly comprises a groove head 11, a neck 12 and a quadrangular part 13, wherein, the neck 12 is located between the groove head 11 and the quadrangular part 13, and the two ends of the neck 12 are respectively connected with the groove head 11 and the quadrangular part 13. Moreover, the inside of the nipple body 1 is configured with a big opening 14 and a small opening 15 connected with each other, wherein, the diameter of the big opening 14 is larger than that of the small opening 15, and the radial length of the big opening 14 is smaller than that of the small opening 15.

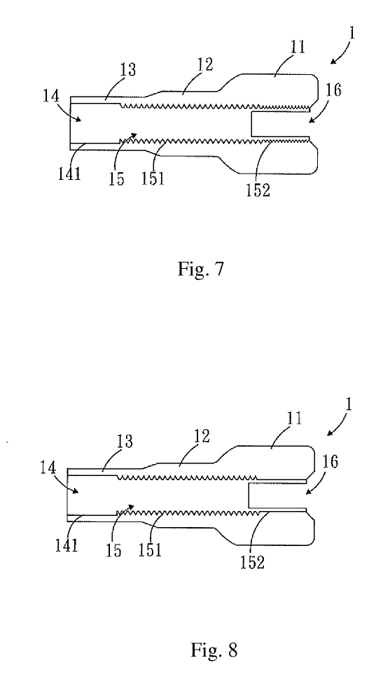

Here, the big opening 14 is located on the side of the quadrangular part 13, while the small opening 15 is located on the neck 12 and the groove head 11, and is formed with a groove 16 on one end of the small opening 15, i.e., the groove 16 is formed on one side of the inside of the groove head 11. Further, the inside of the big opening 14 is configured with a big opening untapped area 141, and one end inside the small opening 15 near the big opening untapped area 141 is configured with a small opening tapped area 151, and the side adjacent to the groove 16 is configured with a clamping area 152, so that the small opening tapped area 151 is located between the big opening untapped area 141 and the clamping area 152. Moreover, the length of the small opening tapped area 151 and the clamping area 152 is lower than the length of the threads 21 of the spoke 2. Further, small opening tapped area 151 can preferably have 2-3 thread more than the bottom of the groove 16 (see FIGS. 7 and 8). However, it is noted that the present invention shall not be restricted by this.

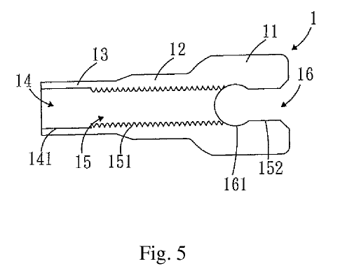

Referring to FIG. 5, based on the above descriptions, the end of the groove 16 can be further configured with a buffer area 161. Moreover, in this embodiment, the clamping area 152 is an untapped groove area.

When the spoke 2 is inserted from the big opening 14 into the nipple body 1, and through the buffer area 161 into the clamping area 152, the threads 21 of the spoke 2 presses the clamping area 152 and start tapping, forming new thread to offer better clamping resilience to clamp the spoke 2.

FIG. 7 discloses the second embodiment of the present invention. In this embodiment, the end of the groove 16 is not configured with a buffer area 161, and the clamping area 152 is configured with a shallow-tapped groove area formed through tapping. The small opening tapped area 151 is connected with the shallow-tapped groove area. As resistance in the shallow-tapped groove area is lower than the untapped area, when the threads 21 of the spoke 2 go into the clamping area 152, deeper new thread will be formed along the thread inside the shallow-tapped groove area.

FIG. 8 discloses the third embodiment of the present invention. In this embodiment, the end of the groove 16 is not configured with a buffer area 161, and the clamping area 152 is an untapped groove area. The small opening tapped area 151 is connected with the untapped groove area to obtain tightest new thread and meanwhile maximum clamping resilience.

The present invention provides a production method of anti-shock spoke nipples, comprising the following steps:

Step 1: provide a nipple body, comprises a groove head 11, a neck 12 and a quadrangular part 13.

A spoke nipple body 1, comprising a groove head 11, a neck 12 and a quadrangular part 13, wherein, the neck 12 is located between the groove head 11 and the quadrangular part 13, and the two ends of the neck 12 are respectively connected with the groove head 11 and the quadrangular part 13.

Step 2: drill a opening from the quadrangular part 13 through the neck 12 till the groove head 11, to form a big opening 14 and a small opening 15 connected with each other, wherein the big opening 14 is on the side of the quadrangular part 13, and the big opening 14 is drilled first and the small opening 15 is drilled later. However, the present invention is not limited by this.

Wherein, the diameter of the big opening 14 is larger than that of the small opening 15, and the radial length of the big opening 14 is lower than that of the small opening 15. Moreover, the big opening 14 is located on the side of the quadrangular part 13, while the small opening 15 is located on the neck 12 and the groove head 11.

Step 3: The groove head 11 is grooved to form a groove 16, and the groove 16 is located on one side of the small opening 15.

One side of the small opening 15 is grooved to form a groove 16, i.e., the groove 16 is formed on one side of the inside of the groove head 11.

Step 4: the inside of the small opening 15 is threaded, and a clamping area 152 is formed inside the small opening 15 on the side of the groove 16. Between the big opening 14 and the clamping area 152, a small opening tapped area 151 is formed.

The end of the groove 16 can be further configured with a buffer area 161. Moreover, the clamping area 152 is an untapped groove area, or, it can be a shallow-threaded groove area formed by threading. Description of this part is same as above and is not repeated here.

Inside of the big opening 14 is configured with a big opening untapped area 141, and one end inside the small opening 15 near the big opening untapped area 141 is configured with a small opening tapped area 151, and the side adjacent to the groove 16 is configured with a clamping area 152, so that the small opening tapped area 151 is located between the big opening untapped area 141 and the clamping area 152. Moreover, the length of the small opening tapped area 151 and the clamping area 152 is lower than the length of the threads 21 of the spoke 2.

When the spoke 2 goes in from the big opening 14 toward the small opening 15, the threads 21 of the spoke 2 are tightened with the small opening tapped area 151 and then the clamping area 152, and part of the threads 21 are located inside the big opening untapped area 141, and the other part of the threads 21 are located inside of the clamping area 152. In this way, through the resilience generated by the groove 16 of the groove head 11, the clamping area 152 can fix and clamp the spoke 2 screwed in, so that the threads of the small opening tapped area 151 and the clamping area 152 can be firmly screwed together with the threads 21 of the spoke 2, avoiding breakage of the screw thread and effectively enhancing the anti-shock performance. Therefore, the present invention can reduce the number of spokes and further realize the goal of lightweight.

Although the invention has been explained in relation to its preferred embodiment, it is to be understood that many other possible modifications and variations can be made without departing from the spirit and scope of the invention as hereinafter claimed.

1. A spoke nipple with an anti-shock structure and its manufacturing method includes the following steps:
Step 1: to provide a nipple body, said nipple body comprises a groove head, a neck and a quadrangular part.
Step 2: to drill a opening from the said quadrangular part through the said neck till the said groove head in such way to form a large opening and a small opening connected with each other;
Step 3: said groove head is then grooved to form a groove on one side of the said small opening;
Step 4: to form a clamping area in inside of the said small opening and to form a small opening tapped area between the said big opening and the said clamping area.

2. The spoke nipple with an anti-shock structure and its manufacturing method as claimed in claim 1, wherein said clamping area is an untapped groove area.

3. The spoke nipple with an anti-shock structure and its manufacturing method as claimed in claim 1, wherein said clamping area is a shallow-threaded groove area formed by threading.

4. The spoke nipple with an anti-shock structure and its manufacturing method as claimed in claim 1, wherein said small opening near one end of the said groove area formed a buffer area.

5. The spoke nipple with an anti-shock structure and its manufacturing method as claimed in claim 1, wherein said anti-shock spoke nipple comprises:
a groove head, a neck and a quadrangular part, wherein, said neck is located between said groove head and said quadrangular part, and the two ends of said neck are respectively connected with said groove head and said quadrangular part;
whereas the inside of said nipple body is configured with a big opening and a small opening connected with each other, wherein, the diameter of said big opening is larger than that of said small opening, and the radial length of said big opening is smaller than that of said small opening.

6. The spoke nipple with an anti-shock structure and its manufacturing method as claimed in claim 5, wherein said big opening is located on the side of said quadrangular part, while said small opening is located between said neck and said groove head; a groove is configured on one end of said small opening;

7. The spoke nipple with an anti-shock structure and its manufacturing method as claimed in claim 6, wherein said groove is formed on one side of the inside of the groove head; the inside of said big opening is configured with a big opening untapped area, and one end inside said small opening near said big opening untapped area is configured with a small opening tapped area, and the side adjacent to said groove is configured with a clamping area, in such configuration that said small opening tapped area is located between said big opening untapped area and said clamping area.

8. The spoke nipple with an anti-shock structure and its manufacturing method as claimed in claim 6, wherein at one end of the said groove can be configured with a buffer area.

9. The spoke nipple with an anti-shock structure and its manufacturing method as claimed in claim 6, wherein said clamping area can be configured with a shallow-tapped groove area formed through tapping

10. The spoke nipple with an anti-shock structure and its manufacturing method as claimed in claim 6, wherein said spoke nipple main body further comprises: a buffer area located within the small opening and at the end of the groove.
